(19) United States
(12) Patent Application Publication
(10) Pub. No.: US 2020/0307439 A1
(43) Pub. Date: Oct. 1, 2020

(54) STOWABLE ENCLOSURE ASSEMBLY

(71) Applicant: Galen W. Yoder, Goshen, IN (US)

(72) Inventor: Galen W. Yoder, Goshen, IN (US)

(21) Appl. No.: 16/829,154

(22) Filed: Mar. 25, 2020

Related U.S. Application Data
(60) Provisional application No. 62/824,555, filed on Mar. 27, 2019.

(51) Int. Cl. B60P 3/34

(52) U.S. Cl. CPC B60P 3/341; B60R 2011/0056

(57) ABSTRACT

A stowable enclosure assembly that includes a storage unit configured for being removably connected to a surface of an existing structure and a stowable framework that includes at least one arm and at least one arm mount connected to the storage unit. The at least one arm is connected and movable relative to the at least one arm mount. The stowable enclosure assembly further includes an enclosure material connected to the at least one arm. The stowable framework and the enclosure material are together configured for moving in between a folded stored position and an unfolded position for defining an enclosure.

### CROSS REFERENCE TO RELATED APPLICATIONS

This is a non-provisional application based upon U.S. provisional patent application Ser. No. 62/824,555, entitled “STOWABLE SHOWER ENCLOSURE”, filed Mar. 27, 2019, which is incorporated herein by reference.

### BACKGROUND OF THE INVENTION

### 1. Field of the Invention

The present invention relates to enclosures, and, more particularly, to a stowable enclosure which may be used in conjunction with an existing structure, such as a vehicle or a trailer.

### 2. Description of the Related Art

For certain recreational activities, such as camping outdoors, it is desirable to create additional temporary enclosures for personal use. For example, tents or canopies may be used to create a private or semi-private enclosure for personal occupancy. Additionally, for example, portable bathrooms that include a pole assembly and a curtain may be used to create a private shower enclosure. Some temporary enclosures may be standalone enclosures which create usable space without incorporating the aid of a wall or other surface of an existing object. Other temporary enclosures may incorporate an existing surface, such as a sidewall of a vehicle, in order to create additional usable space.

For instance, a tent-like enclosure may be attached to an opened rear hatch of a hatchback vehicle in order to create additional usable space that is exterior to the vehicle. Such tent-like enclosures may include a pole assembly that is connected to the rear hatch and a curtain or canvas that defines an enclosure. The pole assembly may include multiple poles that removably connect to one another to define a frame that extends downwardly from the rear hatch. The curtain may be affixed to the rear hatch and/or the poles. Hence, the curtain may define the sides of the enclosure and the opened rear hatch may define the top of the enclosure. As can be appreciated, it may be time-consuming and cumbersome for the operator to assemble all of the various components of these tent-like enclosures.

What is needed in the art is a cost-effective and portable device for creating a personal enclosure.

### SUMMARY OF THE INVENTION

The present invention provides a portable and stowable enclosure assembly for creating an enclosure. The stowable enclosure assembly may be used in conjunction with an existing structure. The stowable enclosure assembly includes a storage unit configured for being removably connected to the vehicle or the trailer and a stowable framework that includes at least one arm and at least one arm mount connected to the storage unit. The at least one arm is connected and movable relative to the at least one arm mount. The stowable enclosure assembly further includes an enclosure material connected to the at least one arm. The stowable framework and the enclosure material are together configured for moving in between a folded stored position and an unfolded position for defining an enclosure.

The present invention in one form is directed to a stowable enclosure assembly usable in conjunction with a surface of an existing structure. The stowable enclosure assembly includes a storage unit configured for being removably connected to the vehicle or the trailer and a stowable framework that includes at least one arm and at least one arm mount connected to the storage unit. The at least one arm is connected and movable relative to the at least one arm mount. The stowable enclosure assembly further includes an enclosure material connected to the at least one arm. The stowable framework and the enclosure material are together configured for moving in between a folded stored position and an unfolded position for defining an enclosure.

The present invention in another form is directed to a method for creating and removing additional usable space for an existing structure. The method includes an initial step of providing a stowable enclosure assembly that includes a storage unit and a stowable framework including at least one arm and at least one arm mount connected to the storage unit. The at least one arm is connected and movable relative to the at least one arm mount. The stowable enclosure assembly further includes an enclosure material connected to the at least one arm. The stowable framework and the enclosure material are together configured for moving in between a folded stored position and an unfolded position for defining an enclosure. The method also includes the step of connecting the storage unit to a surface of the existing structure. The method also includes the step of assembling the enclosure by unfolding the at least one arm and unfolding the enclosure material such that the stowable framework and the enclosure material are positioned in the unfolded position to define an enclosure. The method also includes the step of disassembling the enclosure by folding the enclosure material and folding the at least one arm such that the stowable framework and the enclosure material are positioned in the folded stored position.

An advantage of the stowable enclosure assembly of the present invention is that the user may easily mount the storage unit to a wall member of a vehicle and unfold the stowable framework to create a private enclosure.

Another advantage of the stowable enclosure assembly of the present invention is that the arms of the stowable framework may be efficiently locked into their extended position by pivoting the arms outwardly in an opposing manner and moving the arms downwardly within respective notches of the arm mounts, thereby creating a sturdy structural framework for the enclosure using fewer components.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a stowable enclosure assembly, wherein the stowable enclosure assembly is in an unfolded usable position;

FIG. 2 is a perspective view of the stowable enclosure assembly of FIG. 1, wherein the stowable enclosure assembly is in a folded stored position;

FIG. 3 is a perspective view of one of the arms of the stowable enclosure assembly of FIGS. 1-2 in an extended and locked position;

FIG. 4 is a perspective view of the arm of FIG. 3 in a partially folded position;

FIG. 5 is a perspective view of another embodiment of a stowable enclosure assembly, wherein the stowable enclosure assembly is in a stored position; and

FIG. 6 is a front view of another embodiment of a storage unit of a stowable enclosure assembly.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

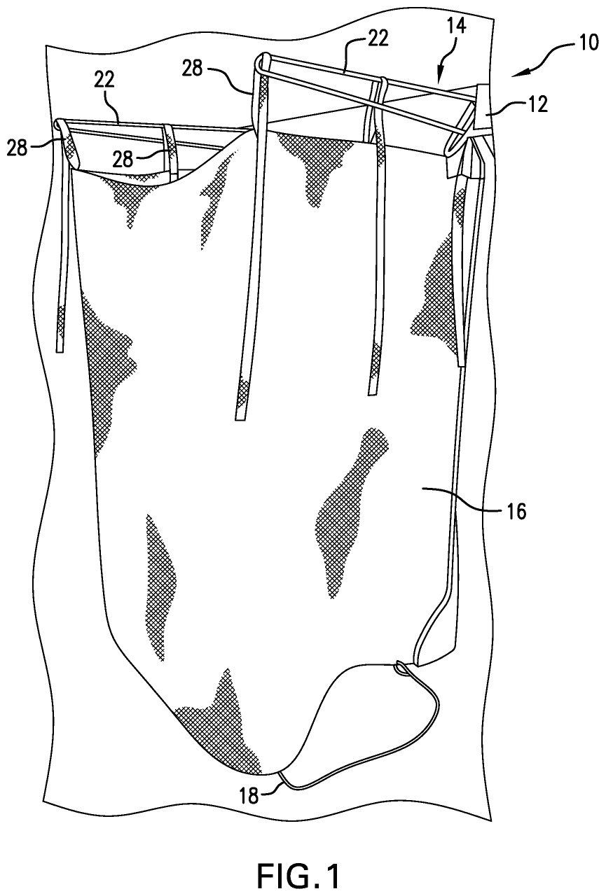

Referring now to the drawings, and more particularly to FIGS. 1-4, there is shown a portable and stowable privacy enclosure assembly 10 for creating a usable space within an enclosure. The stowable enclosure assembly 10 may be in the form of a shower enclosure assembly 10 for creating a temporary shower. The stowable enclosure assembly 10 can be added to the interior or exterior of a vehicle, a boat, a trailer, or another existing structure or object. For instance, the stowable enclosure assembly 10 may be mounted to a Recreational Vehicle (RV), a motorhome, or a tree. Hence, the stowable enclosure assembly 10 may be accessed from the inside or outside of the trailer, vehicle, or structure. Additionally, for example, the stowable enclosure assembly 10 may be mounted onto a ramp door, e.g. on the bottom or top of the ramp door, of the RV or cargo trailer. It should be appreciated that the stowable enclosure assembly 10 may create any desired usable space. For example, the stowable enclosure assembly 10 may create a shelter, shower, kitchen, bathroom, or living space, such as a room, patio, or porch.

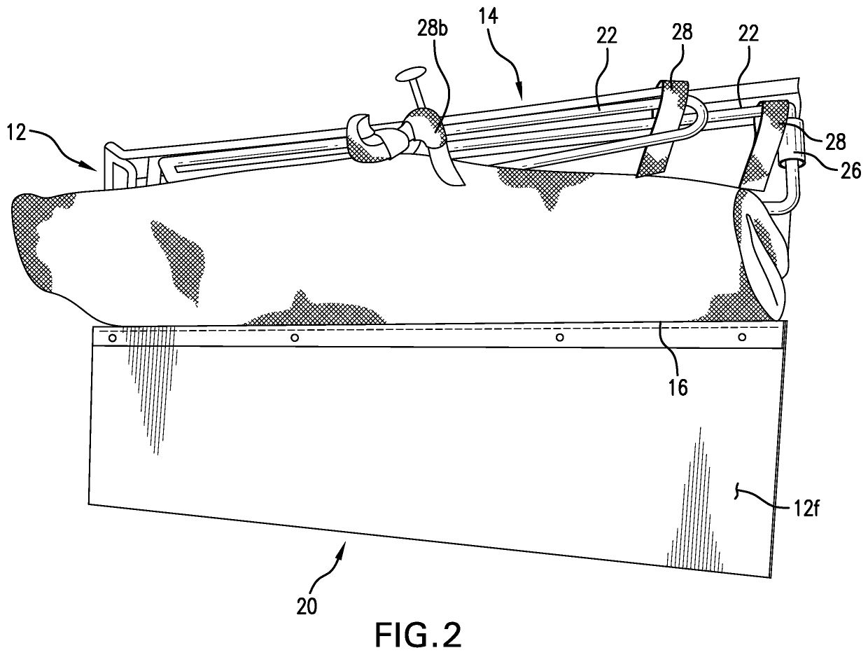

The stowable enclosure assembly 10 may generally include a storage unit 12, a stowable framework 14, and an enclosure material 16 removably coupled with the stowable framework 14. The stowable framework 14 and the enclosure material 16 can be stowed within the storage unit 12 in a folded, stored position (FIG. 2) or unfolded in order to create the body, i.e., define the enclosure, of the stowable enclosure assembly 10 in an unfolded position (FIG. 1). As used herein, the term “stored position” may refer to any position in which the stowable framework 14 and the enclosure material 16 do not create a formed enclosure and are placed within the storage unit 12 or another location. The term “unfolded position” may refer to any position in which the stowable framework 14 and the enclosure material 16 create an at least partially enclosed structure. The stowable enclosure assembly 10 may also include a mat or a floor member 18 as well as a roof section.

The storage unit 12 may be in the form of a bag or box 12 that is attached to a surface of an existing structure. For instance, the storage unit 12 may removably connect to a member or portion of a trailer, vehicle, or other existing object. The storage unit 12 may be fixedly or removably mounted to the portion via fasteners, attachment brackets, hook and loop fasteners, suction cups, zippers, and/or magnets. The storage unit 12 can have four sides including a selectively closable portion 12F (FIG. 2). For example, the closable portion 12F may be the front side or lid 12F of the storage unit 12, and the front side 12F may move to open or close the storage unit 12. The front side 12F may be hinged to the bottom side of the storage unit 12. The storage unit 12 may include a latch 20 or zipper so that the front side 12F may pivot, slide, and/or unzip so that a user may access the framework 14 and the enclosure material 16 (FIG. 2). For example, a user may unlatch the latch 20, pivot the front side 12F downwardly, and accordingly unfold the framework 14 and the enclosure material 16. When the front side 12F is open, the inside of the storage unit 12 may function as a shelf to store accessories or personal items, such as a bar of soap, a shaver, a mirror, or any other accessory. The storage unit 12 may comprise any desired material such as metal, plastic, wood, and/or fabric. It should be appreciated that the shower mat 18 may also be stored within the storage unit 12.

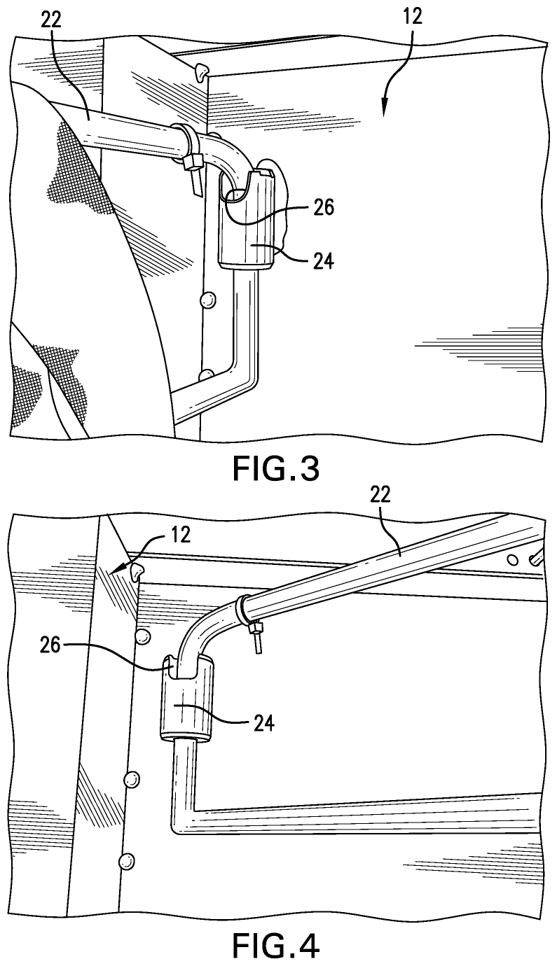

The stowable framework 14 may be movably connected to the interior of the storage unit 12. The stowable framework 14 may include at least one arm 22, at least one arm mount 24, and/or at least one locking feature 26 (FIGS. 3-4). For example, the stowable framework 14 can include a pair of arms 22, a pair of arm mounts 24, and a pair of locking features 26 which are each associated with a respective arm mount 24. Hence, the stowable framework 14 may include only two arms 22, only two arm mounts 24, and only two locking features 26.

Each arm 22 can be pivotally and/or slidably connected to the storage unit 12. For example, each mount 24 may dually pivotally and slidably mount each arm 22 to the storage unit 12. Each arm 22 may fold inwardly to completely reside within the storage unit 12 in the stored position (FIG. 2) and fold outwardly to at least partially extend outside of the storage unit 12 in the unfolded position (FIG. 1). The arms 22 may move in an opposing manner. Each arm 22 may be in the form of a pipe, a bar, or a beam. For example, each arm 22 may be in the form of an endless bar 22. Each endless bar 22 may at first be connected with a respective arm mount 24, and may subsequently be welded to itself to form the endless loop. Thereby, the endless bars 22 remain permanently connected to the arm mounts 24. Additionally or alternatively, each arm 22 may include multiple sections for telescoping relative to the storage unit 12. Each arm 22 may comprise any desired material such as metal, plastic, and/or wood.

Each arm mount 24 can be fixedly or removably connected to the storage unit 12. Each arm mount 24 can be in the form of a bracket, bushing, or a sleeve. For example, each arm mount 24 can be in the form of a bored out cylindrical bushing 24 that is welded onto the interior of the storage unit 12. In this regard, each arm 22 may pivot about the longitudinal axis of each arm mount 24 and may slide vertically up and down relative to each arm mount 24. Furthermore, each arm mount 24 can include at least one respective locking feature 26 in the form of a notch 26 at the top of each arm mount 24. In this regard, the arms 22 can be swiveled outwardly into the extended position and be moved downwardly to contact the notch 26 in order to thereby lock the arms 22 in the extended position (FIG. 3). Alternatively, the locking features 26 may be in the form of separate members which are connected to the arm mounts 24 and/or arms 22. It should be appreciated that the stowable framework 14 may not include the locking features 26.

The enclosure material 16 may be removably connected to and suspended from the arms 22. The enclosure material 16 may be connected to each arm 22 by connecting members 28, such as adjustable straps, loops, hooks, magnets, and/or fasteners. As shown, the connecting members 28 are in the form of adjustable straps 28 (FIG. 2). Additionally, a bottom or floor strap 28B may fasten the enclosure material 16 after it has been folded in the stored position (FIG. 2). The enclosure material 16 may be uniform or multi-sectional as well as flexible or rigid. The enclosure material 16 may be made of a canvas, vinyl, and/or fabric shower curtain or a series of pivotally connected solid walls. As shown, the enclosure material 16 is in the form of a shower curtain 16 with four sides. The enclosure material 16 may be unfolded and accordingly folded and/or rolled into the storage box 12 in the stored position (FIG. 2). In the stored position, the enclosure material 16 may remain connected to each arm 22 or the enclosure material 16 may be disconnected from each arm 22 and stored within the storage unit 12 or in another location. The enclosure material 16 can be weighted at its bottom end so that it may easily unfold under the force of gravity. It should be appreciated that the enclosure material 16 may have a slit in one side and/or a zipper for entering and exiting the enclosure. The enclosure material 16 may also include a canvas roof or foldable roof. It should be appreciated that any portion or member of the enclosure material 16 could also be attached to an RV or cargo trailer ramp door on the bottom or top. Hence, a portion of the vehicle or trailer could serve as the side, floor, and/or ceiling of the enclosure which is at least partially defined by the enclosure material 16. The enclosure material 16 may also include a roller, e.g. roller drum, which is connected to each arm 22 and which accordingly rolls up the fabric material 16.

In operation, the user may assemble or disassemble the stowable enclosure assembly 10 in order to create or remove additional usable space for existing structure, such as a vehicle or trailer. As can be appreciated, the additional usable space created by the enclosure of the stowable enclosure assembly 10 may be exterior or interior to the vehicle or trailer. To assemble the enclosure, the user may position the stowable enclosure assembly 10 in the unfolded position. Hence, the user may unlatch or unzip the storage unit 12, place the floor mat 18 on the ground, and pivot each arm 22 so that each arm 22 extends out from the storage unit 12. Each arm 22 may then be moved downwardly and locked within the notches 26 of the arm mounts 24. The enclosure material 16 may automatically unwrap in conjunction with the motion of the arms 22 or the user may manually unfold the enclosure material 16. The user may then use the private or semi-private enclosure of the stowable enclosure assembly 10. To dismantle the enclosure, the user may position the enclosure assembly 10 in the stored position. Hence, the user may move each arm 22 upwardly out of each notch 26 to unlock the arms 22 and subsequently fold the arms 22 within the storage unit 12. Next or concurrently therewith, the user may fold the enclosure material 16. Thereby, the stowable framework 14 and the enclosure material 16 may be folded and entirely located within the storage unit 12. Thereafter, the user may close the storage unit 12 by latching or zipping the storage unit 12.

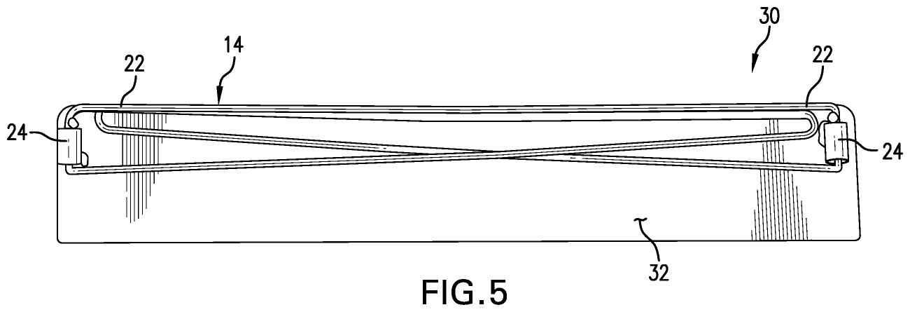

Referring now to FIG. 5, there is shown another embodiment of a stowable enclosure assembly 30 according to the present invention. The stowable enclosure assembly 30 may be substantially similar to the stowable enclosure assembly 10 except that the stowable enclosure assembly 30 includes a mounting plate 32 instead of the storage unit 12, as shown in FIGS. 1-4. The stowable framework 14 is directly mounted onto the mounting plate 32. The mounting plate 32 may be fixedly or removably connected to a portion of a vehicle, trailer, wall, or other object. For example, the mounting plate 32 may include one or more rear mounting brackets (not shown) for connecting the mounting plate 32 to the desired portion of the vehicle. The stowable enclosure assembly 30 may not be stored or housed within a storage unit, such as a box or bag. Alternatively, the stowable enclosure assembly 30 can be selectively disconnected from the vehicle, trailer, wall, etc., and be stored within an accompanying bag (not shown). It is noted that the stowable enclosure assembly 30 includes the enclosure material 16 although the enclosure material 16 is not illustrated in FIG. 5.

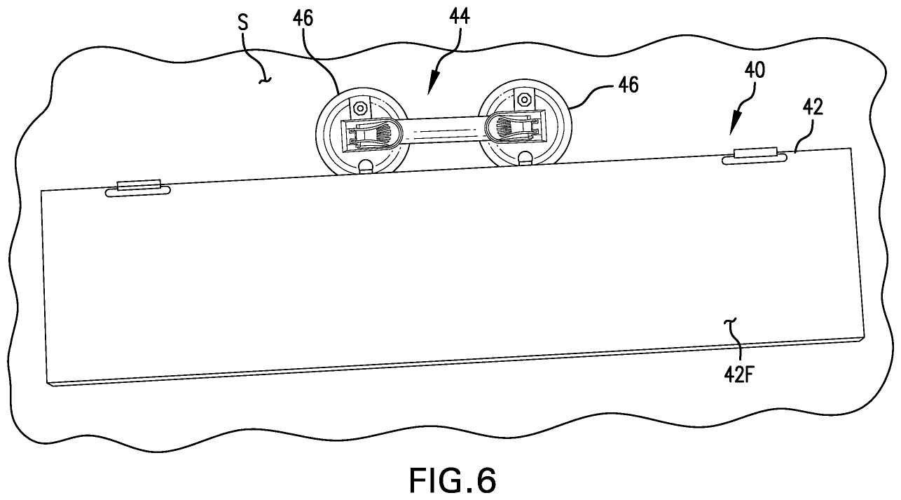

Referring now to FIG. 6, there is shown another embodiment of a stowable enclosure assembly 40 according to the present invention. The stowable enclosure assembly 40 may be substantially similar to the stowable enclosure assembly 10 except that the stowable enclosure assembly 40 includes a differing storage unit 42 and a suction cup device 44 for removably connecting the storage unit 42 to the surface S of an existing structure such as a side of an RV, trailer, exterior or interior wall, etc. The storage unit 42 may be in the form of a box 42. The box 42 may include a front lid 42F that is hinged to a top side member. The box 42 may comprise any desired material, such as plastic. The suction cup device 44 may be attached to the top side member of the box 42. The suction cup device 44 may include a pair of suction cups 46 that selectively grip onto the surface S via pivotable levers 48.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A stowable enclosure assembly usable in conjunction with a surface of an existing structure, comprising:
a storage unit configured for being removably connected to the surface of the existing structure;
a stowable framework including at least one arm and at least one arm mount connected to the storage unit, the at least one arm being connected and movable relative to the at least one arm mount; and
an enclosure material connected to the at least one arm, wherein the stowable framework and the enclosure material are together configured for moving in between a folded stored position and an unfolded position for defining an enclosure.

2. The stowable enclosure assembly of claim 1, wherein the at least one arm includes two arms and the at least one arm mount includes two arm mounts, and the two arms are respectively slidably and rotatably connected to the two arm mounts.

3. The stowable enclosure assembly of claim 1, wherein the at least one arm includes only two arms and the at least one arm mount includes only two arm mounts.

4. The stowable enclosure assembly of claim 3, wherein the two arms are in the form of endless bars.

5. The stowable enclosure assembly of claim 1, wherein the at least one arm mount includes a locking feature for selectively locking the at least one arm in the unfolded position.

6. The stowable enclosure assembly of claim 5, wherein the locking feature is in the form of a notch that is located at a top of the at least one locking feature, and the notch receives and locks the at least one arm in the unfolded position.

7. The stowable enclosure assembly of claim 1, wherein the storage unit includes a closable portion that is openable so that the at least one arm extends outside of the storage unit in the unfolded position and closeable so that the storage unit houses the at least one arm in the stored folded position.

8. The stowable enclosure assembly of claim 1, wherein the storage unit is one of a box and a bag.

9. The stowable enclosure assembly of claim 1, further comprising a suction cup device connected to the storage unit, and the suction cup device is configured for removably connecting to the surface of the existing structure.

10. The stowable enclosure assembly of claim 9, wherein the suction cup device includes a pair of suction cups.

11. A method for creating and removing additional usable space for an existing structure, comprising:
providing a stowable enclosure assembly that includes a storage unit, a stowable framework including at least one arm and at least one arm mount connected to the storage unit, the at least one arm being connected and movable relative to the at least one arm mount, and an enclosure material connected to the at least one arm, wherein the stowable framework and the enclosure material are together configured for moving in between a folded stored position and an unfolded position for defining an enclosure;
connecting the storage unit to a surface of the existing structure;
assembling the enclosure by unfolding the at least one arm and unfolding the enclosure material such that the stowable framework and the enclosure material are positioned in the unfolded position to define an enclosure; and
disassembling the enclosure by folding the enclosure material and folding the at least one arm such that the stowable framework and the enclosure material are positioned in the folded stored position.

12. The method of claim 11, wherein the at least one arm includes two arms and the at least one arm mount includes two arm mounts, and the two arms are respectively slidably and rotatably connected to the two arm mounts.

13. The method of claim 11, wherein the at least one arm includes only two arms and the at least one arm mount includes only two arm mounts.

14. The method of claim 13, wherein the two arms are in the form of endless bars.

15. The method of claim 11, wherein the at least one arm mount includes a locking feature, and the method includes a further step of locking the at least one arm in the unfolded position.

16. The method of claim 15, wherein the locking feature is in the form of a notch that is located at a top of the at least one locking feature, and the notch receives and locks the at least one arm in the unfolded position.

17. The method of claim 11, wherein the storage unit includes a closable portion that is openable so that the at least one arm extends outside of the storage unit in the unfolded position and closeable so that the storage unit houses the at least one arm in the stored folded position.

18. The method of claim 11, wherein the storage unit is one of a box and a bag.

19. The method of claim 11, further comprising a suction cup device connected to the storage unit, and the suction cup device is configured for removably connecting to the surface of the existing structure.

20. The method of claim 19, wherein the suction cup device includes a pair of suction cups.
